(19) United States
(12) Patent Application Publication
(10) Pub. No.: US 2024/0384831 A1
(43) Pub. Date: Nov. 21, 2024

(54) Self-Stabilizing Platforms and Related Methods

(71) Applicant: Rocky Mountain Robotech Inc., Superior, CO (US)

(72) Inventors: Chunbiao GU, Superior, CO (US); Shichao ZHANG, Superior, CO (US); Kolton LEE, Boulder, CO (US)

(21) Appl. No.: 18/199,923

(22) Filed: May 20, 2023

(51) Int. Cl. F16M 11/20; B60R 11/00

(52) U.S. Cl. CPC F16M 11/2035; B60R 11/00; B60R 2011/0003

(57) ABSTRACT

Self-stabilizing devices counteract external forces to maintain a surface of a platform in a predetermined attitude (orientation in space relative to a reference plane, e.g., ground). The platform is linked to an actuator through a universal joint that allows movement in more than one dimension, and the actuator is responsive to instructions from a controller receiving data from an inertial measurement unit. The self-stabilizing platform may, for example, be a serving tray carried by an autonomous robotic vehicle navigating uneven terrain and/or experiencing abrupt changes in momentum.

### CROSS-REFERENCE TO RELATED APPLICATIONS

None.

### STATEMENT REGARDING FEDERALLY SPONSORED RESEARCH

None.

### BACKGROUND

Self-stabilizing devices that rapidly adjust to counteract disruptive stimuli are used, for example, in photography, videography, surgery, aviation, science, and other fields. In the food service industry, self-stabilizing devices have typically been limited to gimbaled or swinging stoves, for example, on boats. On land, the food service industry relies upon humans carrying trays to physically adjust to external forces. However, human response times may be too slow, or human instincts may incorrectly interpret stimuli, leading to spills and breakage. As the food service industry begins to embrace the use of autonomous robotic vehicles (ARVs) for serving and bussing, there is an opportunity to reduce or remove human error.

### SUMMARY

The present devices and methods maintain a surface of a platform in a predetermined attitude (orientation in space relative to a reference point or plane, e.g., ground). Such a platform may, for example, be a serving tray, a vehicle chassis, a vehicle body, a beverage holder or table within a vehicle, a camera mount, an instrument table, or any other platform expected to encounter unwanted external forces. As an example, a food service tray carried by or forming part of an ARV may be subjected to external forces associated with uneven flooring and/or abrupt starting, stopping, and/or turning forces. Such a food service tray-incorporating one of the self-stabilizing platforms disclosed herein-can counteract the unwanted force(s) to ensure an upper surface of the tray remains level so that items and liquids on the tray do not fall or spill.

In an aspect, a self-stabilizing platform comprises an upper plate having a top surface; a backing unit disposed below a bottom surface of the upper plate; at least one actuator linking the upper plate and the backing unit through a universal joint; an inertial measurement unit collecting data indicative of movement of the backing unit; and a controller receiving the data from the inertial measurement unit and instructing the at least one actuator to counteract the movement of the backing plate, thereby keeping the top surface of the upper plate level.

In an embodiment, an actuator is a rotary actuator.

In an embodiment, an actuator may be fixedly connected to a proximal end of a toggle joint. A distal end of the toggle joint may form a yoke connected to a cross of a universal joint, and a second yoke connected to the cross of the universal joint may extend from the bottom surface of the upper plate of a self-stabilizing platform. In an embodiment, a distal end of the toggle joint forms a ball that mates with a socket extending from the bottom surface of the upper plate, or vice versa, a distal end of the toggle joint forms a socket that mates with a ball extending from the bottom surface of the upper plate. In an embodiment, the universal joint is selected from the group consisting of a Hooke joint, a ball-and-socket joint, and a magnetic ball joint.

In an embodiment, a self-stabilizing platform comprises three actuators arranged in an equilateral triangular configuration between the upper plate and the backing unit. Each of the three actuators may be fixedly connected to a proximal end of a toggle joint that is oriented along a median of the equilateral triangular configuration.

In an embodiment, a self-stabilizing platform comprises four actuators arranged in a square configuration between the upper plate and the backing unit. Each of the four actuators is fixedly connected to a proximal end of a toggle joint that is oriented along a diagonal of the square configuration.

In an embodiment, an actuator comprises a brush motor, a brushless motor, or a step motor.

In an embodiment, the backing unit forms part of an autonomous robotic vehicle. For example, the backing unit may be directly or indirectly connected to an autonomous robotic vehicle. In an embodiment, the upper plate of the self-stabilizing platform is a tray carried by an autonomous robotic vehicle.

In an embodiment, the controller of the self-stabilizing platform is a proportional-integral-derivative (PID) controller. In an embodiment, the controller of the self-stabilizing platform is in communication with a control unit of the autonomous robotic vehicle.

In an embodiment, a self-stabilizing platform comprises a wireless communication unit. For example, the wireless communication unit may include a magnetic sensor, a near field communication device, an antenna, an optical scanner, a Wi-Fi transceiver, a Bluetooth®-enabled device and/or a Zigbee-enabled device. The wireless communication unit may, for example, enable payment and/or item (e.g., pager, phone, tablet) detection by the self-stabilizing platform and/or communication between the self-stabilizing platform and a local area network (LAN) or cloud platform.

In an embodiment, an inertial measurement unit is selected from a magnetometer, an accelerometer, a gyroscope or combinations thereof.

In an aspect, a method of using a self-stabilizing platform comprises providing an upper plate having a top surface and a backing unit disposed below a bottom surface of the upper plate with at least one actuator linking the upper plate and the backing unit through a universal joint; collecting data indicative of movement of the backing unit with an inertial measurement unit; receiving the data from the inertial measurement unit at a controller; and instructing the at least one actuator to counteract the movement of the backing plate, thereby keeping the top surface of the upper plate level.

In an embodiment, the method of using the self-stabilizing platform further comprises forming the backing unit as part of an autonomous robotic vehicle or attaching the backing unit to an autonomous robotic vehicle, and optionally placing items on the top surface of the upper plate and moving the autonomous robotic vehicle over uneven ground.

### BRIEF DESCRIPTION OF THE DRAWINGS

Illustrative embodiments of the present invention are described in detail below with reference to the attached drawings, wherein:

FIG. 1 is a top perspective view illustrating components of a self-stabilizing platform, according to an embodiment;

FIG. 2 is a side view of the self-stabilizing platform of FIG. 1;

FIG. 3 is a schematic showing components of an actuator of a self-stabilizing platform, according to an embodiment;

FIG. 4 is a block diagram showing measurement and control components of a self-stabilizing platform, according to an embodiment;

FIG. 5 shows four actuators arranged in a square configuration with actuator arms oriented along diagonals of the square, according to an embodiment;

FIG. 6 shows three actuators arranged in an equilateral triangular configuration with actuator arms oriented along medians of the triangle, according to an embodiment;

FIG. 7 shows components of a Hooke's joint, according to an embodiment;

FIG. 8 shows components of a magnetic ball joint, according to an embodiment;

FIG. 9A, FIG. 9B and FIG. 9C are schematics showing movement of components of a self-stabilizing platform to counteract external forces, according to an embodiment;

FIG. 10 illustrates external forces acting on an object resting on a top surface of a self-stabilizing platform and a defeat angle that counters the external forces;

FIG. 11 is a block diagram of feedback loops responsive to acceleration and slope of a self-stabilizing platform, according to an embodiment; and

FIG. 12 illustrates an autonomous robotic vehicle having a plurality of self-stabilizing platforms as components thereof, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

A “device” is a combination of components operably connected to produce one or more desired functions.

A “component” is used broadly to refer to an individual part of a device.

As used herein, a “self-stabilizing” device or method is one that provides a force to counteract an exogenous force, thereby maintaining a substantially and perpetually fixed orientation for at least one component of the device relative to a reference point or plane, such as the ground. A “self-stabilizing” device or method that maintains a surface in a horizontal position (parallel to the ground) may also be referred to as a “self-leveling” device or method.

A “toggle joint” is a mechanical linkage of two bars at ends thereof allowing the bars to pivot around the joint and open into a relatively straight line.

A “universal joint” is a joint that can move in more than one dimension. For example, a Hooke joint or Hooke's joint comprises a pair of rods each having a yoke that joins with an axis of a cross or “spider”. The Hooke's joint allows rotation in two dimensions, namely, around the two axes defined by the cross. Ball-and-socket joints or magnetic ball joints comprise a ball that mechanically and/or magnetically mates with a socket to allow rotation in three dimensions.

An inertial measurement unit (IMU) is an electronic sensor that detects linear acceleration using accelerometers and rotational rate using gyroscopes. The IMU allows tracking of a body's speed, acceleration, turn rate and inclination.

A magnetometer may be used to obtain a heading reference.

“Proximal” and “distal” refer to the relative positions of two or more objects, planes or surfaces. For example, an object that is closer in space to a reference point relative to the position of another object is considered proximal to the reference point, whereas an object that is further away in space from a reference point relative to the position of another object is considered distal to the reference point.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third object).

As used herein, the terms “processor” and “computer” and related terms, e.g., “processing device”, “computing device”, and “controller” are not limited to just those integrated circuits referred to in the art as a computer, but broadly refer to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

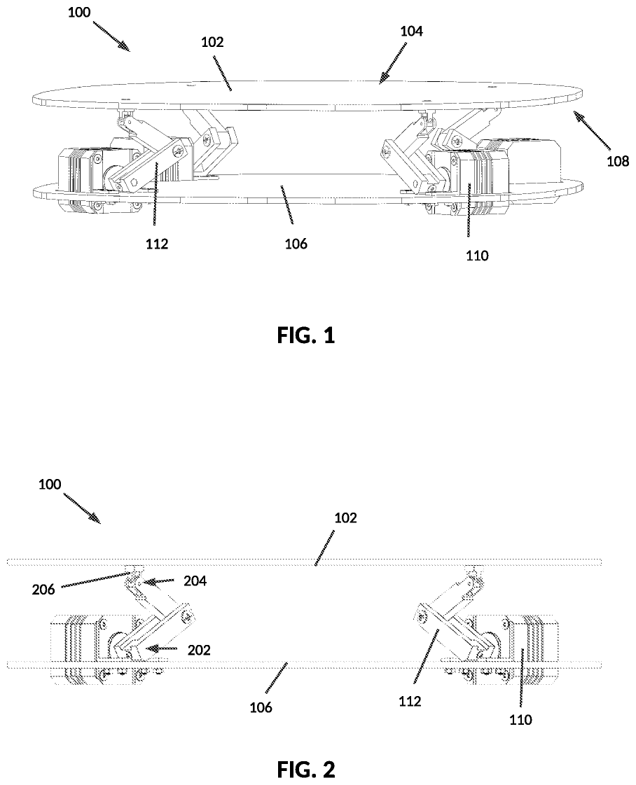

Exemplary self-stabilizing platforms can be seen in FIGS. 1-12. Multiple items within a figure may not be labeled for clarity.

FIG. 1 is a top perspective view illustrating components of a self-stabilizing platform 100, according to an embodiment. Self-stabilizing platform 100 includes an upper plate 102 having a top surface 104, a backing unit 106 disposed below a bottom surface 108 of upper plate 102, at least one actuator 110 linking upper plate 102 and backing unit 106 through an actuator arm(s) forming a toggle joint 112. Actuator 110 may, for example, be a rotary actuator comprising a brush motor, a brushless motor, or a step motor.

FIG. 2 is a side view of self-stabilizing platform 100 of FIG. 1. As shown, actuators 110 are fixedly connected to a proximal end 202 of toggle joint 112. A distal end 204 of toggle joint 112 is connected to a universal joint 206 extending from bottom surface 108 of upper plate 102.

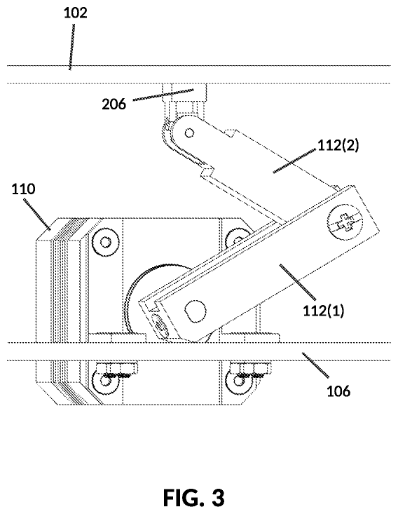

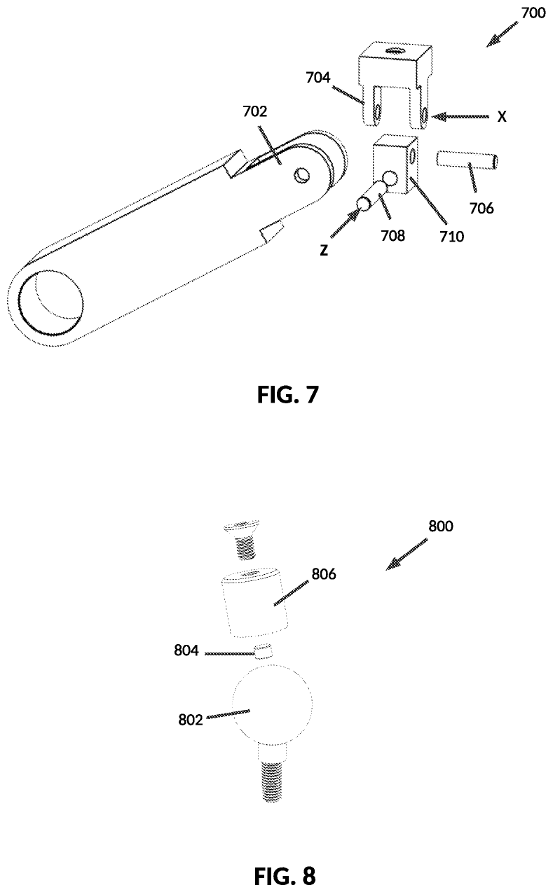

FIG. 3 is a side view of an actuator 110 connected to a toggle joint formed by first and second arms 112(1), 112(2) pivotally attached to one another. A distal end of second arm 112(2) is joined with universal joint 206, which allows for rotation in more than one dimension. Universal joint 206 may, for example, be a Hooke's joint (FIG. 7) or a magnetic ball joint (FIG. 8). Overall, the zigzag shape provided by the toggle joint and universal joint allows rolling motion to be converted into a vertical distance change.

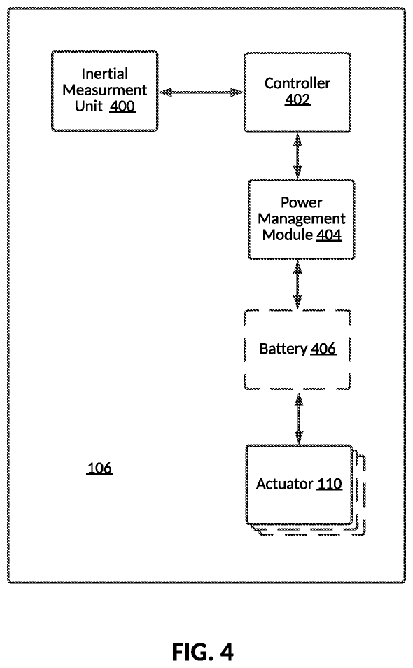

FIG. 4 is a block diagram showing measurement and control components of a self-stabilizing platform 100, according to an embodiment. As shown, the components are attached to backing unit 106, but the components could alternatively be mounted on bottom surface 108 of upper plate 102 or on a combination of backing unit 106 and upper plate 102. Self-stabilizing platform 100 may include one or more of an inertial measurement unit 400, a controller 402, a power management module 404, and/or a battery 406. In operation, inertial measurement unit 400 may be a magnetometer, an accelerometer, a gyroscope or combinations thereof. Data from inertial measurement unit 400 may be sent to controller 402, which may be an application-specific integrated circuit (ASIC) or a field-programmable gate array (FPGA), for example. In response to data from the inertial measurement unit 400, controller 402 sends a signal(s) to a power management module 404, which arranges for power to be sent to one or more actuators 110. For example, power may be supplied by a battery 406 or a power source that is external to the self-stabilizing platform (e.g., power from an ARV carrying the self-stabilizing platform).

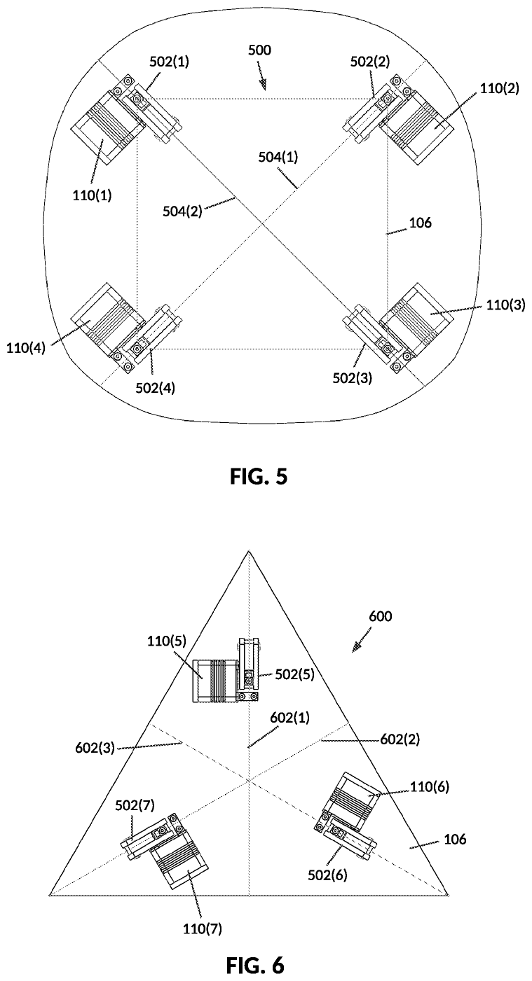

FIG. 5 shows four actuators 110(1)-110(4) of a self-stabilizing platform arranged in a square configuration 500 with actuator arms 502(1)-502(4), such as toggle joint arms, oriented along diagonals 504(1), 504(2) of the square, according to an embodiment. When the actuators are connected by a backing unit 106, which may be a solid square unit, a square frame, a unitary cross, a pair of beams joined at their mid-points to form a cross or any other shape, actuators 110(1) and 110(3) will operate as a first pair and actuators 110(2) and 110(4) will operate as a second pair.

FIG. 6 shows three actuators 110(5)-110(7) arranged in an equilateral triangular configuration 600 with actuator arms 502(5)-502(7), such as toggle joint arms, oriented along medians 602(1)-602(3) of the triangle, according to an embodiment. When the actuators are connected by a backing unit 106, which may be a solid square unit, a square frame, a solid triangular unit, a triangular frame, or any other shape, the actuators operate independently.

FIG. 7 shows components of a Hooke's joint 700, according to an embodiment. Hooke's joint 700 includes a first yoke 702 and a second yoke 704. A pair of offset axles 706, 708 that form a cross or “spider” when fixed relative to one another by a support 710. Axle 706 fits between the arms of second yoke 704 and allows for rotation around the X axis, while axle 708 fits between the arms of first yoke 702 and allows for rotation around the Z axis. Thus, Hooke's joint 700 is a universal joint that provides rotation in more than one dimension, namely, the X and Z dimensions.

FIG. 8 shows components of a magnetic ball joint 800, where a ball 802 mates with a magnet 804 housed within a concave socket 806. Both the ball 802 and socket 806 can be secured to other components via screws. Magnetic ball joint 800 is a universal joint that can rotate in more than one dimension. Particularly, ball 802 may rotate in any dimension that is not physically blocked by socket 806.

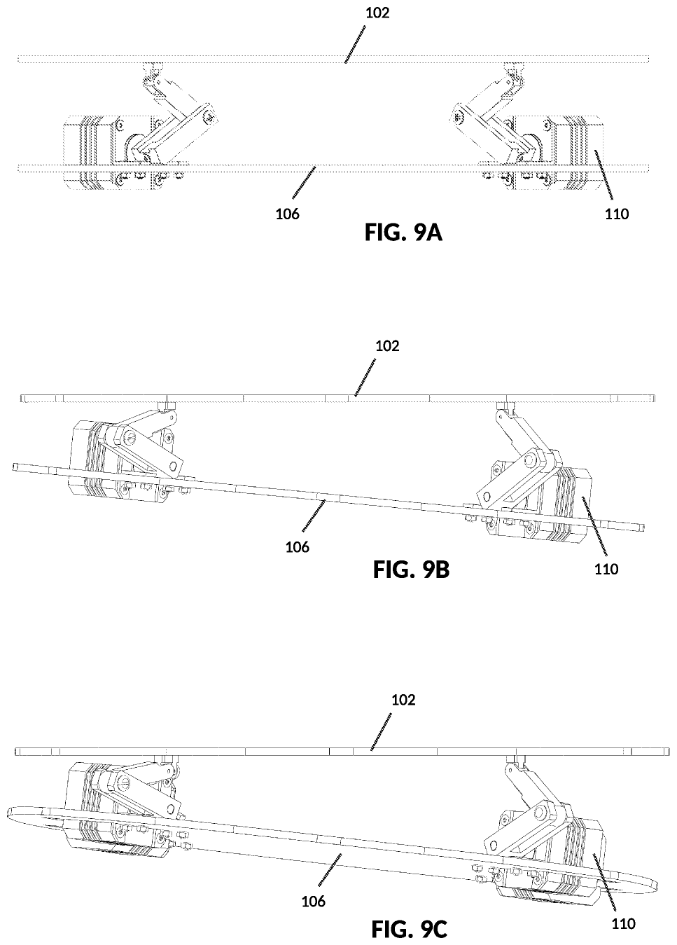

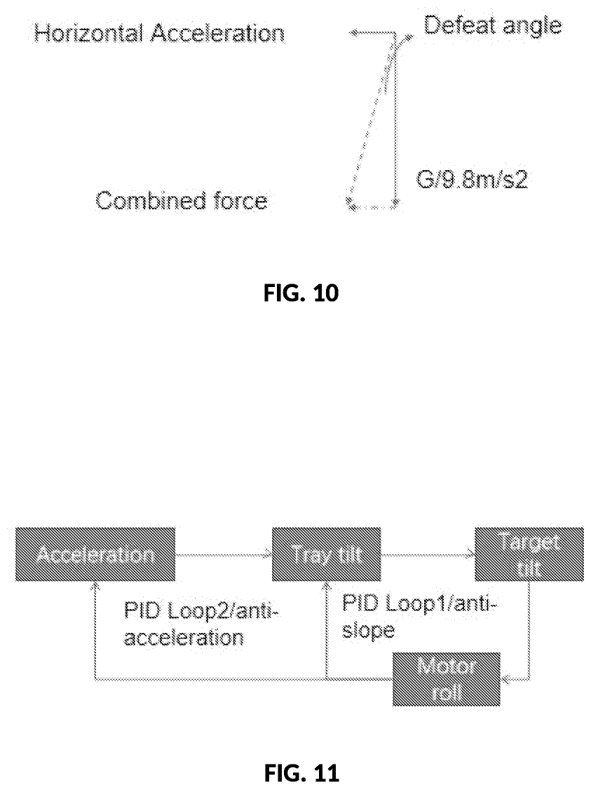

FIG. 9A, FIG. 9B and FIG. 9C are schematics showing movement of components of a self-stabilizing platform to counteract external forces. In FIG. 9A, an initial position of an upper plate 102 and a backing unit 106, before any counter force is applied via actuators 110, illustrates a substantially parallel alignment of upper plate 102 and backing unit 106. Once an external force is encountered, one or more actuators 110 induce movement of backing unit 106 in two-dimensions or three-dimensions. In FIG. 9B, orientation of backing unit 106 after a two-dimensional movement in the x-y plane is shown. For comparison, FIG. 9C shows the orientation of backing unit 106 after a three-dimensional manipulation. These movements allow external forces to be counteracted such that the original attitude of upper plate 102 is maintained. The desired combined force of gravity and horizontal acceleration is as close to 180 degrees as possible, i.e., along the y-axis. When the combined horizontal acceleration and gravity forces deviate from 180 degrees, as shown in FIG. 10, a defeat angle is calculated to determine the counter forces necessary to reduce or eliminate the unwanted external forces.

One or more proportion-integral-derivative algorithms (e.g., executed by a processor within controller 402) utilize tilt and/or acceleration data received in real time from inertial measurement unit 400 to convert the detected movement into a target tilt adjustment parameter that is continually provided to a motor(s) of the actuator(s) via one or more feedback loops, illustrated in FIG. 11 as an anti-acceleration loop and an anti-slope loop.

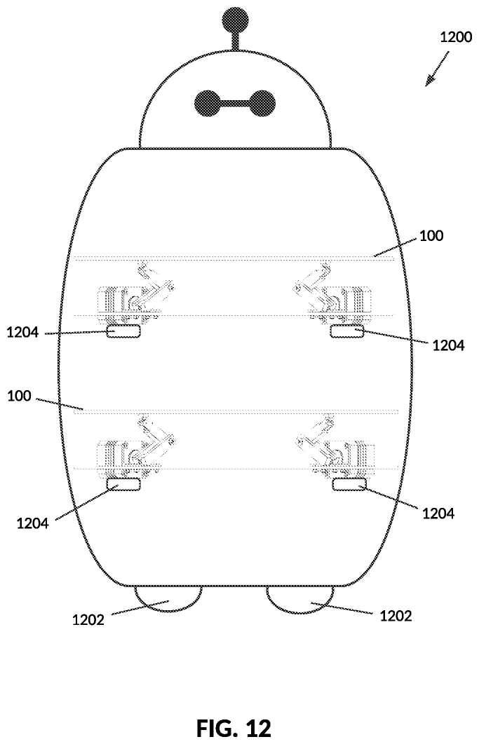

FIG. 12 illustrates an autonomous robotic vehicle 1200 that is moveable upon one or more wheels 1202. The ARV comprises one or more self-stabilizing platforms 100 that are mounted to the ARV, for example, by a plurality of brackets 1204. As shown, the brackets are attached to bottom surfaces of each actuator, but the brackets may also or alternatively be attached to a backing unit or other component of the self-stabilizing platform. Each self-stabilizing platform of the ARV is independent of any other self-stabilizing platform(s) of the ARV.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a processor” includes a plurality of such processors and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements or limitation or limitations which is/are not specifically disclosed herein.

What is claimed is:

1. A self-stabilizing platform comprising:
an upper plate having a top surface;
a backing unit disposed below a bottom surface of the upper plate;
at least one actuator linking the upper plate and the backing unit through a universal joint;
an inertial measurement unit collecting data indicative of movement of the backing unit; and
a controller receiving the data from the inertial measurement unit and instructing the at least one actuator to counteract the movement of the backing unit, thereby alleviating forces on the upper plate to maintain a predetermined attitude of the upper plate.

2. The self-stabilizing platform of claim 1, wherein the at least one actuator is a rotary actuator.

3. The self-stabilizing platform of claim 1, wherein the at least one actuator is fixedly connected to a proximal end of a toggle joint.

4. The self-stabilizing platform of claim 3, wherein a distal end of the toggle joint forms a yoke connected to a cross of the universal joint.

5. The self-stabilizing platform of claim 4, wherein a second yoke connected to the cross of the universal joint extends from the bottom surface of the upper plate.

6. The self-stabilizing platform of claim 3, wherein a distal end of the toggle joint forms a ball that mates with a socket extending from the bottom surface of the upper plate.

7. The self-stabilizing platform of claim 3, wherein a distal end of the toggle joint forms a socket that mates with a ball extending from the bottom surface of the upper plate.

8. The self-stabilizing platform of claim 1, wherein the universal joint is selected from the group consisting of a Hooke joint, a ball-and-socket joint, and a magnetic ball joint.

9. The self-stabilizing platform of claim 1, wherein the at least one actuator comprises three actuators arranged in an equilateral triangular configuration between the upper plate and the backing unit.

10. The self-stabilizing platform of claim 9, wherein each of the three actuators is fixedly connected to a proximal end of a toggle joint that is oriented along a median of the equilateral triangular configuration.

11. The self-stabilizing platform of claim 1, wherein the at least one actuator comprises four actuators arranged in a square configuration between the upper plate and the backing unit.

12. The self-stabilizing platform of claim 11, wherein each of the four actuators is fixedly connected to a proximal end of a toggle joint that is oriented along a diagonal of the square configuration.

13. The self-stabilizing platform of claim 1, wherein the actuator comprises a brush motor, a brushless motor, or a step motor.

14. The self-stabilizing platform of claim 1, wherein the backing unit forms part of an autonomous robotic vehicle.

15. The self-stabilizing platform of claim 1, wherein the backing unit is directly or indirectly connected to an autonomous robotic vehicle.

16. The self-stabilizing platform of claim 1, wherein the upper plate is a tray carried by an autonomous robotic vehicle.

17. The self-stabilizing platform of claim 1, wherein the controller is a proportional-integral-derivative (PID) controller.

18. The self-stabilizing platform of claim 17, wherein the controller is in communication with a control unit of the autonomous robotic vehicle.

19. The self-stabilizing platform of claim 1 further comprising a wireless communication unit.

20. The self-stabilizing platform of claim 1, wherein the inertial measurement unit is selected from a magnetometer, an accelerometer, a gyroscope or combinations thereof.
